(19) United States
(12) Patent Application Publication
(10) Pub. No.: US 2021/0276112 A1
(43) Pub. Date: Sep. 9, 2021

(54) SOLDERING TOOL FOR INDUCTIVE SOLDERING

(71) Applicant: SAINT-GOBAIN GLASS FRANCE, COURBEVOIE (FR)

(72) Inventors: Bernhard REUL, Herzogenrath (DE); Cynthia HALM, Aachen (DE)

(21) Appl. No.: 17/261,770

(22) PCT Filed: Jul. 18, 2019
(86) PCT No.: PCT/EP2019/069388

§ 371 Date: Jan. 20, 2021

(30) Foreign Application Priority Data
Jul. 20, 2018 (EP) 18184599.1

(51) Int. Cl. B23K 3/047; B23K 1/00; B23K 1/002; B23K 1/20; H05B 6/10; H05B 6/14; B23K 3/08; H05B 6/42; H05B 6/36

(52) U.S. Cl. CPC B23K 3/0475; B23K 1/0016; B23K 1/002; B23K 1/203; B23K 2101/36; H05B 6/14; B23K 3/085; H05B 6/42; H05B 6/365; H05B 6/101

(57) ABSTRACT

A soldering tool for inductive soldering, includes an induction loop and an induction generator that is electrically conductively connected to the induction loop, wherein the induction loop consists of a metal profiled element, has at least one U-shaped region or two U-shaped regions, and each U-shaped region has in each case two legs and an end region connecting the legs, the at least one U-shaped region has a length L of at least 3 mm to 500 mm and a width B of 2 mm to 30 mm.

The invention relates to a soldering tool and a device with an integrated soldering tool for inductive soldering.

Modern automobile or architectural glazings often have a variety of electrical functions, such as antennas, electric heaters, or electric lighting elements. These are usually contacted by conductor structures with solder connection surfaces on the plate surface. The conductor structures usually consist of a well-known fired thick film of a screen printing paste with a relatively high silver content.

Subsequently, contact elements are soldered to the conductor structures via a solder. The solder forms an electrical connection and often a mechanical connection as well between the conductor structures and the supply lines that are connected to the contact element.

The soldering operation can be carried out, for example, by a contact soldering method, in which two electrodes with a certain distance between them are placed on the electrically conductive contact element. Then, the contact element is heated by an electric current that flows from one electrode to the other using ohmic resistance heating.

Alternatively, the soldering operation can be carried out by induction soldering. Here, for example, a magnetic field, a high-frequency magnetic field, is coupled into the conductor structure, the solder, and the contact element by a coil situated on the surface of the plate facing away from the conductor structure. This uses the ability of the magnetic field to transfer the energy required to melt the solder through the plate without contact. Such a method is known, for example, from DE 10 2004 057 630 B3.

Other methods for heating or soldering by means of induction are known, for example, from CN 203 936 495 U, JP H05 261526 A, JP 2014 232615 A, U.S. Pat. Nos. 4,197,441 A, or 4,415,116 A.

The object of the present invention is now to specify an improved soldering tool for inductive soldering.

This object is accomplished by a soldering tool according to the invention with the features of claim 1.

The features of the subordinate subclaims indicate advantageous further developments of the invention and a device with the soldering tool.

The method according to the invention is accomplished through the features of a further claim.

The soldering tool for inductive soldering according to the invention comprises at least:
an induction loop and
an induction generator that is electrically conductively connected to the induction loop,
   wherein the induction loop
consists of a metal profiled element, preferably of a metal solid profiled element or of a metal hollow profiled element,
has at least one U-shaped region or two U-shaped regions, and each U-shaped region has in each case two legs and an end region connecting the legs,
the at least one U-shaped region has a length L of at least 3 mm, preferably from 3 mm to 500 mm, and a width (distance between legs) B from 2 mm to 30 mm, preferably from 4 mm to 25 mm.

In the following, the end region is also referred to as the reversal region since, there, the direction of extension of the first leg is reversed into an opposite direction of extension of the second leg. This end region or reversal region serves as the soldering tip of the loop. In other words, the end region or reversal region is arranged closest to a solder joint to be soldered or to a contact element to be soldered. From there, the induction field is coupled into the solder joint or into the contact element. The end region or reversal region is consequently essential for the heating of the solder joint and thus serves as an energy source for its heating.

The induction loop according to the invention does not have a complete coil turn or, in other words, the induction loop is a not locally closed turn. “Not locally closed” means that the surface enclosed by the induction loop is not completely enclosed in the projection relative to the surface normal of the enclosed surface. Thus, the induction loop also differs from prior art induction loops.

Induction loops according to the invention are particularly compact and easy to manufacture and can be used universally for a large number of common connection elements.

The induction loop according to the invention consists of a metal profiled element. The metal profiled element is made of at least one metal, preferably of copper or silver-plated copper, of aluminum or metallic sintered materials. Metals, and in particular copper or aluminum, are good electrical conductors and are, consequently, particularly suitable for guiding the AC voltage signal from the induction generator into the end region of the induction loop and decoupling it there for heating a solder joint or a contact element.

The metal profiled element is preferably a solid profiled element or a hollow profiled element. Here, “solid profiled element” means that the metal profiled element is completely filled in and, in particular, has no cavities apart from any pores. The cross-section of the metal profiled element can, in principle, have any cross-section. The metal profiled element advantageously has a round, oval, elliptical, or circular cross-section and is then a wire in the case of the solid profiled element or a tube or a round tube in the case of the hollow profiled element. Alternatively, the metal profiled element can have an angular cross-section, for example, a rectangular or square cross-section.

The induction loop is preferably implemented in one piece and is, for example, formed from a metal profiled element by cold or hot bending. Such induction loops are particularly easy to manufacture. The hollow profiled element is preferably seamless in its direction of extension. However, it can also be welded or otherwise connected.

It goes without saying that the induction loop can also be produced by joining and connecting a plurality of metal profiled sections made of the same or different materials.

In an advantageous embodiment of the induction loop according to the invention, the hollow profiled element has an inner diameter Di of 0.3 mm to 5 mm, preferably of 0.5 mm to 3 mm, and in particular of 0.75 mm to 1.25 mm. In another advantageous embodiment of the induction loop according to the invention, the hollow profiled element has an outer diameter Da of 0.75 mm to 7.0 mm, preferably of 1.0 mm to 5.0 mm, and in particular of 1.25 mm to 2.5 mm.

In another advantageous embodiment, the induction loop according to the invention has at least two tube connections that are connected to a hollow space arranged in the interior of the induction loop and that are suitable for connecting to a cooling unit for pumping a liquid coolant through the interior of the induction loop. The liquid coolant preferably contains or is cooling water and particularly preferably is essentially water or water/glycol mixtures. The tube connections are advantageously situated at the ends of the legs that are not connected to the end region.

The induction loop is is designed such that each each leg and the end region and any other supply lines form a connected hollow profiled element. This means that the hollow profiled element of the leg is in each case connected to the hollow profiled element of the end region and they form a common hollow space. The one common hollow space is completely closed except for two ends that serve as tube connections. Thus, a coolant, for example, cooling water, can be fed into the induction loop via one tube connection and leave the induction loop without losses via the second tube connection. Preferably, the cooling water is continuously pumped in a cooling water circuit and cooled in a cooling unit. This prevents overheating of the induction loop.

An advantageous induction loop according to the invention has exactly one U-shaped region. This embodiment can be used particularly universally and flexibly and is, for example, suitable for all common solder connections of contact elements for contacting conductor structures on glass panes.

Another advantageous induction loop according to the invention has exactly two U-shaped regions, also referred to in the following as double-U-shaped or W-shaped. The two U-shaped regions can be arranged in one plane. Alternatively, the two U-shaped regions can also be arranged parallel to one another and preferably parallel and congruent one atop the other. Alternatively, the two U-shaped regions can also have an angle, preferably a 90° angle relative to one another. These embodiments can also be used particularly universally and flexibly and are, for example, suitable for all common solder connections of bridge-shaped contact elements for contacting conductor structures on glass panes, providing the capability of soldering two solder connection surfaces simultaneously.

In an advantageous embodiment of the induction loop according to the invention, the end region of each U-shaped region is rounded and preferably arcuate. Particularly advantageous is a semicircular design and, in particular, a semicircular design with a radius R of 2 mm to 20 mm. Here, the end region of each U-shaped region is preferably convex, i.e., curved outward relative to the surface bordered by the legs and the end section. This embodiment can be used particularly universally and flexibly and is, for example, suitable for all common solder connections of contact elements for contacting conductor structures on glass panes.

In an advantageous embodiment of the induction loop according to the invention, the end region of each U-shaped region has a first arcuate section, a rectilinear section, and a second arcuate section. Preferably, the first arcuate section and the second arcuate section have a curvature angle R1 of 0.5 mm to 5 mm. Advantageously, the first arcuate section and the second arcuate section have in each case the shape of a quarter circle.

The U-shaped region according to the invention has a length L of at least 3 mm, preferably of at least 5 mm, more preferably of at least 10 mm, even more preferably of at least 30 mm, and in particular of at least 50 mm. The length L is determined from the length of the legs together with the end region.

The U-shaped region according to the invention advantageously has a length L of at most 500 mm, preferably of at most 300 mm, more preferably of at most 50 mm, in particular of at most 30 mm.

An alternative U-shaped region according to the invention has a length L of 3 mm to 500 mm, preferably of 3 mm to 100 mm, more preferably of 3 mm to 50 mm, even more preferably of 5 mm to 50 mm, and in particular of 5 mm to 30 mm.

The legs of a U-shaped region according to the invention advantageously run substantially parallel. This allows a particularly compact design and easy production of the induction loop. They can also be slightly curved or run at an angle relative to one another, preferably at an angle less than or equal to 90°, particularly preferably less than or equal to 20°, and in particular less than or equal to 10°.

The U-shaped region according to the invention has a width B of 2 mm to 30 mm, preferably of 4 mm to 25 mm. The width B results from the maximum distance between the centers of the legs of the U-shaped region (also referred to in the following as the leg distance). In the case of parallel legs, the width B is constant over the entire length of the legs.

Alternatively, one or both legs of each U-shaped region can also be curved and preferably curved convexly.

In an advantageous embodiment of a soldering tool according to the invention, the induction loop has no magnetic and preferably no soft magnetic material. Soft magnetic materials are ferromagnetic materials and can be readily magnetized in a magnetic field. In particular, the induction loop according to the invention has, in its active area, no soft magnetic or ferromagnetic material, except for a soft magnetic component possibly to be soldered, such as a soft magnetic contact element, soft magnetic solder, soft magnetic conductor structures, and/or their supply line(s). Here, the active area is the area into which the induction field radiates for soldering, i.e., the vicinity of the induction loop, in which a component to be soldered can be heated. It goes without saying that the component and structures to be soldered are not part of the induction loop according to the invention.

In an advantageous embodiment, the soldering tool according to the invention has an enclosure of the induction loop, which is nonmagnetic, at least in sections, and preferably non-soft-magnetic. Particularly preferably, the enclosure is made of a thermally resistant plastic or a ceramic.

In another advantageous embodiment of the soldering tool according to the invention, an enclosure of the induction loop is suitable and designed as a counterholder for fixing a contact element during soldering.

In another advantageous embodiment of a soldering tool according to the invention, the induction generator has an adjustable frequency of up to 1500 kHz, preferably of 5 kHz to 1100 kHz, particularly preferably of 40 kHz to 1100 kHz, even more preferably of 400 kHz to 1100 kHz, and in particular of 700 kHz to 1100 kHz. The adjustable output power of the induction generator is advantageously from 200 W to 15 kW and preferably from 400 W to 3 kW.

The device according to the invention comprises:
means for fastening a plate during the soldering operation,
at least one soldering tool according to the invention having at least one induction loop according to the invention suitable for radiating a magnetic field,
means for mutually positioning the soldering tool and a, preferably soft metallic, contact element such that the switched-on magnetic field of the soldering tool heats the contact element and thus the solder joint, preferably to a temperature above the melting temperature of a solder.

For this, an alternating voltage with a frequency of up to 1500 kHz, preferably of 5 kHz to 1100 kHz, particularly preferably of 40 kHz to 1100 kHz, even more preferably of 400 kHz to 1100 kHz, and in particular of 700 kHz to 1100 kHz, is advantageously generated by the induction generator and introduced into the induction loop.

The device according to the invention thus serves for the inductive soldering of at least one, preferably soft magnetic, contact element to at least one conductor structure on a non-metallic plate.

In an advantageous further development of the device according to the invention, the solder is heated at the solder joint to the soldering temperature, the soldering temperature being a temperature above the melting temperature of the solder at which the solder can or does enter into a soldered connection with the adjacent connection surfaces.

In an advantageous further development of the device according to the invention, the device includes no components for directing and guiding the field lines of the magnetic field and in particular no soft magnetic components in the active area of the induction loop.

This aspect of the invention is based on the finding of the inventors that—when using contact elements made of soft magnetic or ferromagnetic steel, in particular ferromagnetic stainless steel—it is possible to couple the induction field generated by the soldering tool into the contact element without further guidance of the field lines.

In an advantageous embodiment of the device according to the invention, the smallest distance between the induction loop and the contact element is in the end region of the induction loop. In other words: The induction loop comes closest to the contact element in its end or reversal region. In particular, the smallest distance between the end region of the induction loop and a region of the contact element is over or above the second solder connection surface. Here, “over or above” means on the side of the contact element facing away from the second solder connection surface. The end region of the induction loop is the “soldering tip” of the soldering tool. The magnetic induction field used to heat the contact element is radiated from the end region of the induction loop into the contact element.

Heat develops in the metallic and in particular ferromagnetic components of the contact element, heating the adjacent solder deposit and the conductor structure adjacent thereto, thus forming a solder joint.

Contact elements made of ferromagnetic steels with a μᵣ>>1, preferably stainless ferromagnetic steel, are particularly suitable for this. This group includes in particular ferritic steels and stainless ferritic steels, martensitic steels and stainless martensitic steels as well as duplex steels and stainless duplex steels. Duplex steel is a steel that has a two-phase structure that consists of a ferrite (α-iron) matrix with islands of austenite. The polarization of these steels tends to match the external field, channeling and amplifying it.

It goes without saying that it suffices for the contact element to contain a sufficient amount of ferromagnetic steel. In other words, for example, further thin layers of other materials can also be arranged on the contact element, e.g., for corrosion or rust protection or for improving the electrical conductivity or wettability by a solder. In addition, the contact element can also contain further nonmetallic components, for example, an enclosure made of a temperature-resistant plastic or a ceramic. It is particularly preferred for the contact element to be made entirely of ferromagnetic stainless steel.

The conductor structure on the plate contains a (first) solder connection surface. The contact element contains a (second) solder connection surface. The solder connection surfaces are suitable for forming the solder joint with the solder from a solder deposit.

The heat input occurs primarily via the contact element. In other words, the solder connection surface of the contact element is heated directly. As a result, the solder deposit adjacent the contact element is heated, and not until then is the solder connection surface of the conductor structure on the plate heated. This has several critical advantages. Due to the direct heating of the contact element, the necessary energy applied is used in a very targeted manner, yielding energy savings compared to prior art techniques. Due to the only indirect heating of the solder connection surface on the conductor structure of the plate, it is heated very gently such that there is less damage to the conductor structure and the plate.

It goes without saying that the soldering tool can also have more than one induction loop according to the invention, for example, to solder one contact element to multiple solder connection surfaces (e.g., in a bridge configuration) or to simultaneously solder multiple contact elements next to one another (e.g., in a multi-pole configuration).

The soldering tool is arranged directly adjacent the contact element and thus on the side of the plate facing the solder joint and the conductor structure.

In order to achieve consistently high solder quality, it is advantageous to keep the distance between the soldering tool and the contact element as equal as possible with each plate. Here, it is advantageous to provide a very narrow, well-defined air gap, preferably with a gap dimension from 0.1 mm to 5 mm, particularly preferably from 0.25 mm to 5 mm, and in particular from 0.25 mm to 2 mm, between the soldering tool and the contact element, in order to completely avoid contact and electrical short-circuits.

Alternatively, or in combination with an air gap, the soldering tool can also have an electrically insulating intermediate layer or enclosure on its surface facing the contact element, for example, a thermally resistant plastic or a ceramic. It goes without saying that in this configuration, the plate itself does not serve as an intermediate layer.

Alternatively, or in combination with the above, the contact element can also have an electrically insulating intermediate layer or enclosure on its surface facing the soldering tool, for example, made of a thermally resistant plastic or a ceramic.

For series production, the tools can advantageously be installed stationarily in devices or soldering stations in which the plates prepared for producing the solder connections are inserted and positioned. The stationary arrangement of the soldering tools has the further advantage that necessary supply lines do not have to be moved. Alternatively, the soldering tool can be implemented movably, thus enabling more flexible positioning on the plate. In addition, multiple connections can be soldered one after another with one soldering tool.

In an advantageous embodiment of the invention, the device includes at least one counterholder for pressing the contact element onto the plate. In another advantageous embodiment of the invention, the counterholder is combined with gripping tools for positioning the contact elements.

The counterholders or gripping tools are advantageously implemented independent of the soldering tool. There is almost no wear on the soldering tools. Without a soldering tool, counterholders and gripping tools for placing the components to be soldered can be implemented more simply and more compactly and replaced more simply.

Alternative counterholders or gripping tools can advantageously be designed connected to the soldering tool and in particular connected to the induction loop or the induction coil, in particular as an enclosure of the induction loop or the induction coil.

During the soldering operation, the connecting parts are pressed only loosely against the plate surface using counterholders and/or gripping tools, which are themselves not heated by the magnetic field. These tools can be made, for example, of plastic or ceramic or both or outfitted with appropriate nonmetallic inserts in the zones of their contact with the soldering pieces. In particular, the counterholders are made only of non-ferromagnetic and, in particular, non-ferritic materials. This can reduce the coupled electrical power required by the induction generator.

In another advantageous embodiment, the device according to the invention contains a robot for guiding and applying the at least one soldering tool to the plate and/or the plate to the soldering tool.

In another advantageous embodiment, the device according to the invention contains a robot for guiding and applying the counterholder and/or gripping tools.

In another advantageous embodiment, the counterholder and/or the gripping tool has no components for directing and guiding the field lines of the magnetic field and, in particular, no ferromagnetic or ferritic components.

In another advantageous embodiment, no components for directing and guiding the field lines of the magnetic field and, in particular, no ferromagnetic or ferritic components are arranged in the vicinity of the solder joint.

The plates according to the invention are preferably single panes or composite panes comprising two or more individual panes, as are commonly used in the automotive sector and the construction sector. The single pane or individual panes of the composite pane are preferably made of glass, particularly preferably of soda lime glass, as is customary for window panes. However, the plates can also be made of other types of glass, for example, quartz glass, borosilicate glass, or aluminosilicate glass, or of rigid clear plastic, for example, polycarbonate or polymethyl methacrylate.

The conductor structures can include all types of electrical conductors that can be arranged on a plate and are suitable for soldering. These are in particular printed silver conductors, produced from a printed and subsequently fired thick film of a screen printing paste with a relatively high silver content. Alternatively, metal wires or metal foils glued or otherwise attached can also be used as conductor structures.

The invention includes in particular a device for the inductive soldering of at least one, preferably soft magnetic and particularly preferably ferromagnetic, contact element to at least one conductor structure on a nonmetallic plate, comprising
means for fastening the plate during the soldering operation,
at least one soldering tool according to the invention, which comprises
   an induction loop and
   an induction generator that is electrically conductively connected to the induction loop,
wherein the induction loop
   consists of a metal profiled element,
   has at least one U-shaped region or two U-shaped regions, and each U-shaped region has in each case two legs and an end region connecting the legs, and
   the at least one U-shaped region has a length L of at least 3 mm and preferably to 500 mm, and a width B of 2 mm to 30 mm, preferably of 4 mm to 25 mm,
means for mutually positioning the soldering tool and the contact element such that the switched-on magnetic field of the soldering tool heats the contact element and thus the solder joint, preferably to a temperature above the melting temperature of a solder,
at least one counterholder for pressing the contact element onto the plate, wherein, preferably, the counterholder is combined with gripping tools for positioning the contact elements, and
wherein the counterholder and, optionally, the gripping tool has no components for directing and guiding field lines of the magnetic field and, in particular, no ferromagnetic or ferritic components in the active area of the induction loop.

Another aspect of the invention relates to a system consisting of the device according to the invention with a soldering tool according to the invention and at least one, preferably soft magnetic and particularly preferably ferromagnetic, contact element, as well as, preferably, at least one solder deposit, and at least one conductor structure on a nonmetallic plate.

Another aspect of the invention comprises a method for soldering at least one ferromagnetic contact element to at least one conductor structure on a nonmetallic plate, wherein
a) a nonmetallic plate, preferably made of glass or plastic, having at least one conductor structure arranged thereon and at least one first solder connection surface is provided,
b) at least one contact element made of a ferromagnetic steel having at least one second solder connection surface is provided,
c) at least one solder deposit is arranged, at least in sections, on the first solder connection surface or on the second solder connection surface or on both,
d) the second solder connection surface is arranged on the first solder connection surface, wherein the solder deposit is arranged, at least in sections, between the first solder connection surface and the second solder connection surface,
e) a magnetic field with a predefined frequency is radiated into the contact element by a soldering tool comprising an electrically powered induction loop, in order to heat the contact element by induction and melt the solder deposit adjacent thereto.

In a further process step, the magnetic field is advantageously removed, for example, by switching off the supply voltage or by moving the soldering tool away, whereupon the contact element and the solder cool down and the solder solidifies.

In an advantageous embodiment of the method according to the invention, the frequency of the alternating voltage applied to the induction loop is adapted to the connector geometry and set at 1500 kHz.

In an advantageous embodiment of the method according to the invention, the frequency of the magnetic field is in the range from 5 kHz to 1100 kHz, preferably from 40 kHz to 1100 kHz, particularly preferably from 400 kHz to 1100 kHz, and in particular from 700 kHz to 1100 kHz. Such high frequencies of the induction voltage greater than or equal to 400 kHz and in particular greater than or equal to 700 kHz result in a magnetic field with only a small penetration depth. This has the particular advantage that although the contact element, the solder deposit adjacent the second solder connection surface, and thus indirectly also the first solder connection surface of the conductor surface are reliably heated, the conductor structure in the vicinity of the first solder connection surface is heated only slightly. Thus, damage to the conductor structure and detachment of the conductor structure from the plate can be reliably avoided.

The adjustable output power of the induction generator is advantageously set in the range from 200 W to 15 kW and preferably from 400 W to 3 kW.

In an advantageous embodiment of the method according to the invention, the soldering tool is applied to the contact element directly and/or via an electrically insulating intermediate layer (which, in particular, is not the plate itself) or with a narrow air gap.

In another advantageous embodiment of the method according to the invention, the end region of the induction loop is applied to the contact element directly and/or via an electrically insulating intermediate layer (which is, in particular, not the plate itself) or with a narrow air gap.

In an advantageous embodiment of the method according to the invention, the contact element is fixed on the plate before and during the soldering using non-ferromagnetic, preferably non-ferromagnetic, nonmetallic counterholders.

In an advantageous embodiment of the method according to the invention, the plate, the contact element, and the at least one soldering tool are stationarily fixed in a device at least during the soldering operation.

In an advantageous embodiment of the method according to the invention, the first solder connection surface of the conductor structure on the plate or the second solder connection surface of the contact element or both are provided with a lead-containing or a lead-free solder deposit, preferably with integrated or subsequently applied flux.

In an advantageous further development of the method according to the invention, the plate, in particular in the region of the solder connection surface, is additionally heated from the side facing away from the soldering tool. For this, the device according to the invention for example, contains a heater. The additional heating reduces temperature-induced stresses in the region of the solder joint and prevents glass breakage or detachment of the conductor structure from the plate. This is particularly advantageous in the case of glass plates, since the adhesion of the conductor structure to the plate is particularly sensitive there.

Prior art induction coils usually have multiple turns wound around an axis (also called a coil core).

The magnetische flux density B in the interior of an elongated air-filled cylindrical coil results in B=μ₀I-N/L, where I is the current strength, N is the number of turns, L is the coil length, and μ₀ is the magnetic field constant. The direction of the axis is identical to the direction of the coil length L and to the surface normal N, the area enclosed by the turns of the induction coil. To amplify the magnetic field of a coil, suitable material (e.g., ferromagnetic materials) is often introduced into the interior of the coil. The resultant amplification of the magnetic field is taken into account in the above formula with a dimensionless factor, the relative permeability μᵣ, such that the magnetic flux density is then B=μ₀-I-N/L.

If, as the prior art teaches, a coil is used as an induction coil, the materials to be heated are either brought into the interior of the coil (in particular in the case of simple toroidal coils) or into the vicinity of an end face of the coil since the magnetic field lines leave the coil core there and—apart from the interior of the coil—are at their maximum. Usually, the surface normals of the solder connection surfaces of the components to be soldered are arranged parallel to the coil axis (and thus to the surface normals of the coil turns) since this results, based on design technology, in the shortest distance between the solder joint and the end face. This is independent of whether the coil core is air-filled or contains a ferromagnetic material.

The soldering tool according to the invention is based on a completely different principle. The induction loop contains no ferromagnetic material. In contrast, the induction loop is designed such that its end region is at a minimum distance from a ferromagnetic contact element. In the ferromagnetic contact element, the magnetic field emitted from the end region of the induction loop is bundled and amplified. This yields focused heating of the ferromagnetic contact element, without nearly heating more distant ferromagnetic or non-magnetic material. The heated contact element also heats a solder arranged on or in contact with a (second) solder connection surface of the contact element until its soldering temperature is reached. Then, the molten solder heats a (first) solder connection point of another conductor structure to be soldered. The heating is achieved as essential by the focused coupling of the magnetic field out of the end region of the induction loop into the ferromagnetic contact element. The soldering temperature is preferably a temperature above the melting temperature at which the solder forms a soldered joint with the adjacent solder connection surfaces.

In contrast to prior art induction coils, in which the surface normal of the solder connection surfaces is arranged parallel to the coil axis and thus parallel to the surface normal of the of the coil turns, this is not necessary with induction loops according to the invention. Advantageously, the angle α (alpha) between the surface normal of the induction loop and the surface normal of the solder connection surface of the contact element does not equal 0 (zero). Preferably, the angle α (alpha) is 30°, particularly preferably greater than or equal to 45°, and in particular from 50° to 90°.

Further details and advantages of the solution according to the invention are apparent from the accompanying drawings of examples of possible applications and their detailed description.

They depict, schematically and not to scale:

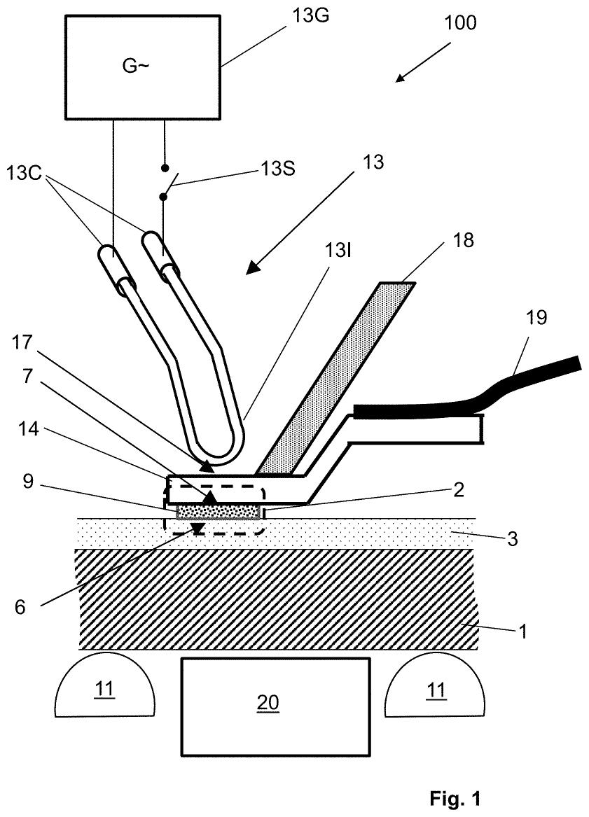

FIG. 1 a schematic representation of a device according to the invention with a soldering tool according to the invention and an enlarged detail of a solder joint according to the invention,

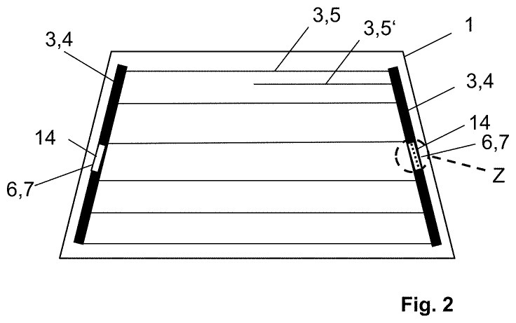

FIG. 2 a view of a pane with contact elements according to the invention,

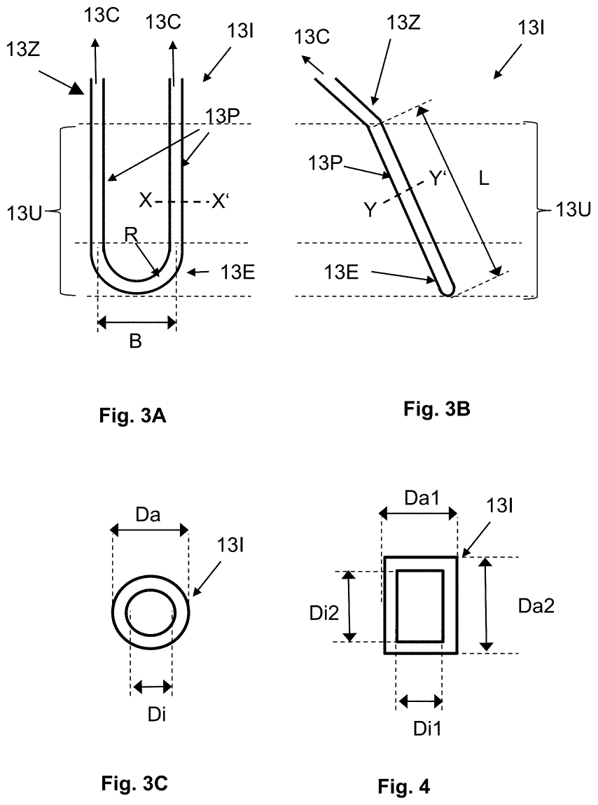

FIG. 3A a detailed representation of the exemplary induction loop 13I of FIG. 1 in plan view,

FIG. 3B a detailed representation of the exemplary induction loop 13I of FIG. 3A in a side view from the left,

FIG. 3C a cross-sectional representation along the section plane spanned by the section line X-X′ of FIG. 3A and the section line Y-Y′ of FIG. 3B,

FIG. 4 a cross-sectional representation of an alternative induction loop made of a hollow profiled element with a rectangular cross-section,

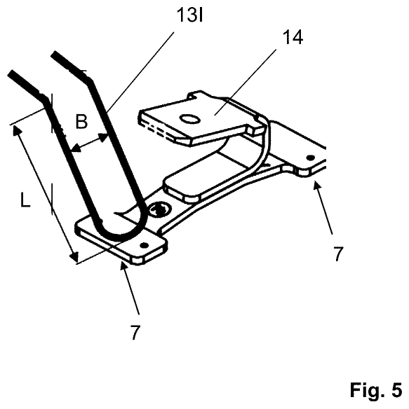

FIG. 5 a perspective representation of an induction loop according to the invention having an exemplary contact element in the form of a bridge,

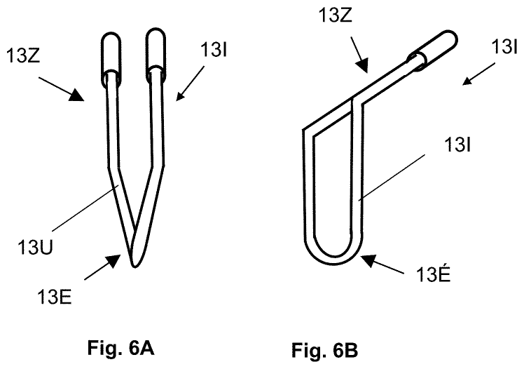

FIG. 6A a detailed representation of another exemplary embodiment of an induction loop according to the invention with a U-shaped region rotated by 90° in plan view,

FIG. 6B a detailed representation of the induction loop of FIG. 6A in a side view from the left,

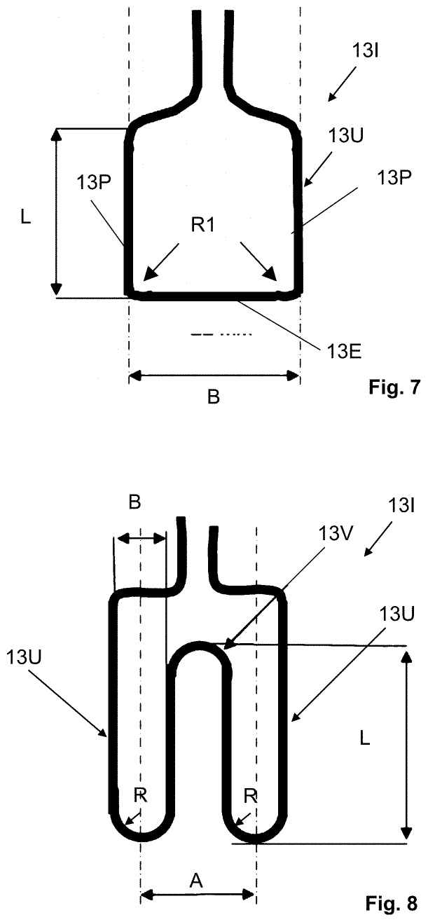

FIG. 7 a detailed representation of another exemplary embodiment of an induction loop according to the invention with a straight reversal region,

FIG. 8 a detailed representation of another exemplary embodiment of a double-U-shaped induction loop according to the invention, and

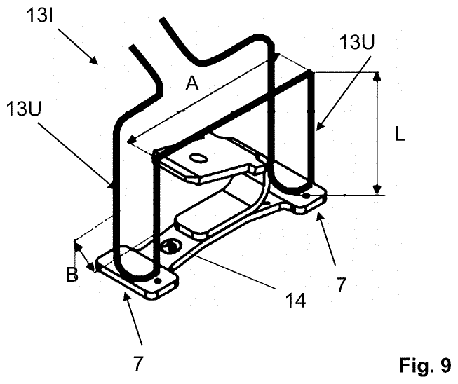

FIG. 9 a perspective representation of an induction loop according to the invention having a rotated double-U-shape and an exemplary contact element in the form of a bridge.

FIG. 1 depicts a schematic representation of a device 100 according to the invention having a soldering tool 13 according to the invention during the soldering of a contact element 14 to a conductor structure 3. FIG. 1 depicts a detail of the pane 1 shown in FIG. 2 based on a cross-sectional representation along the dotted line in the region Z.

FIG. 2 depicts a trapezoidal pane 1 made of glass or plastic, whose upper surface in the viewing direction is provided along its edge with an opaque and, for example, black, electrically nonconductive coating (not shown here, for the sake of simplicity). This is, for example, a rear wall pane of a motor vehicle, shown here simplified without curvature. On its surface, electrical conductor tracks or structures 3, for example, heating conductors 5 and antenna conductors 5′ are also provided, which extend over the field of vision of the pane and/or at the edge all the way to the opaque coating. Busbars 4 are provided along the left and right edge of the pane 1. Also, multiple first solder connection surfaces 6 are provided for the electrical contacting of the conductor structures 3 via the busbars 4, which will be discussed in more detail later. Here, a simplified identical mirror-image configuration of busbars and first solder connection surfaces 6 is indicated. However, in reality, the configurations of the busbars and solder connection surfaces can be different depending on the side of the pane. The first solder connection surfaces 6 can also be arranged on the long sides of the pane shape depicted here.

The layout of the heating conductors 5 and antenna conductors 5′ in the central field of vision of the pane 1 is shown in simplified form only and absolutely does not restrict the invention. It is, in any case, irrelevant for the present description because this is intended only to discuss the establishing of the electrical connections (at the edges, in this case) of the conductor structures 3 by soldering with inductive heat generation.

The conductor structures 3, the busbars 4, and the first solder connection surfaces 6 are usually produced by printing an electrically conductive printing paste in thick-film technology and subsequent firing. The firing on glass panes is preferably done during the heating of the glass pane during bending. The printing is advantageously done by screen printing. The electrically conductive printing paste is advantageously silver-containing.

The pane 1 is inserted into the device 100 that includes, among other things, the soldering tool 13 and means 11 for placing the pane 1 and, optionally, further stops and positioning aids. Here, the support means 11 are, for example, positioned behind/under the pane 1 in the viewing direction; and the soldering tool 13, in front of/above the pane 1. It can, in particular, be seen that the soldering tool 13, which is fixed in the device, is arranged above the first solder connection surface 6 in the vertical projection onto the pane surface.

Also, contact elements 14 are shown. The contact elements 14 have in each case a second solder connection surface 7. This is arranged in the vertical projection onto the pane surface above the first solder connection surface 6. A solder deposit 9 is arranged between the first solder connection surface 6 of the conductor structure 3 of the pane 1 and the second solder connection surface 7 of the contact element 14. After soldering, the solder connection is created between the first solder connection surface 6 and the second solder connection surface 7. Function-appropriate electrical supply lines 19, such as supply lines or connection lines or antenna cables, are connected to the contact elements 14, for example, by crimping, spot welding, screwing, or other connection techniques.

The contact elements 14 contain, for example, a ferromagnetic stainless steel and are substantially made of this material. In other words, the contact element 14 contains at least a core of the ferromagnetic stainless steel. The contact element 14 can, for example, additionally have a sheathing on the surface facing away from the second solder connection point 7, preferably made of a suitable (electrically insulating) plastic. In addition, the contact element 14 can also have, on the surface of the core, thin layers of other metals, not necessarily ferromagnetic, for example, for improved corrosion protection. The special role of the ferromagnetic property of the contact element 14 is discussed further below.

The solder deposit 9 consists of a thin layer of a lead-containing or lead-free solder, optionally with integrated or subsequently applied flux. It can, optionally, suffice to apply a solder deposit 9 on only one of the two surfaces to be soldered in each case, i.e., either on the first solder connection surface 6 or the second solder connection surface 7, if it is ensured that the energy inputted can heat all components sufficiently for good soldering on both sides and the non-tinned surface can be wetted by solder.

The contact element 14, the solder deposit 9, the conductor structure 3, and the pane 1 are depicted here only schematically. This means, in particular, that the thicknesses shown are not to scale.

Here, for example, the contact element 14 is pressed onto the pane 1 by one or a plurality of counterholders 18 and positioned. The counterholders 18 can, for example, and also advantageously, be remotely controlled gripping and positioning tools in an automated production line. They remove the initially loosely movable contact elements 14 from the respective supply magazines, position them on the associated first solder connection surfaces 6, and hold them fixedly during the soldering operation until the solder solidifies.

As shown in FIG. 1, the soldering tool 13 according to the invention is arranged directly above the contact element 14 and, in particular, above the second solder connection surface 7 and the solder deposit 9.

Here, the soldering tool 13 contains an induction loop 13I that is supplied with an alternating voltage with adjustable frequency and power by a commercial induction generator 13G. Furthermore, a switch 13S, with which the operation of the induction loop 13I can be controlled, is indicated symbolically in the connection between the induction generator 13G and the induction loop 13I. Finally, the soldering tool 13 can, if need be, be cooled via tube connections 13C. In deviation from the schematic representation, the supplying of coolant and the electrical supply line are, optionally, combined. For example, the induction loop 13I can consist of a metal profiled element in the form of a metal or metallic hollow profiled element with, for example, a circular cross-section through which the coolant flows and which acts at the same time as a high-frequency induction loop. The hollow profiled element can, for example, be made of silver-plated copper.

Compared to prior art high-frequency induction loops or coils, the soldering tool 13 used here contains a hollow profiled loop whose dimensions correspond substantially to the length and width of the soldering tool. The filling of the intermediate spaces in a manner known per se using bodies made of ferrite or other similarly suitable materials is unnecessary. Such ferrite-free soldering tools 13 can be used in particular in combination with ferromagnetic contact elements 14 in a particularly simple, flexible, and energy-saving manner.

As a result of the arrangement of the soldering tool 13 directly above the ferromagnetic material of the contact element 14, the magnetic field radiated by the induction field is concentrated in or through the contact element 14 and optimized such that it is directed and acts as intensively and concentrated as possible on the solder joints 2. It is thus less important to achieve high homogeneity over large areas than to direct the magnetic field into the specially designed contact element 14. The heating of the contact element 14 results, via the second solder connection surface 7, in a quick and intense heating of the solder deposit 9 and the adjacent first solder connection points 6.

The soldering tool 13 requires no special elements, such as ferrite elements or functionally identical components for shaping and guiding the field lines, as is the case in prior art induction soldering tools. Even the counterholders 18 and other possible components in the vicinity of the soldering tool 13 contain no ferrites or ferromagnetic materials or the like. The concentration of the magnetic field on the solder joint 2 is done only via the ferromagnetic contact element 14. This is particularly efficient and energy-saving. At the same time, the soldering tool 13 is particularly flexibly suitable for a variety of connection configurations and does not have to be adapted to the respective contact element 14 as is required in the prior art.

In order to achieve consistently high soldering quality, it is advantageous to keep the distance between the soldering tool 13 and the contact element 14 as nearly the same as possible for each pane. Here, according to the invention, a very narrow, well-defined air gap 17 of, for example, 0.5 mm is provided between the soldering tool 13 and the contact element 14. Such an air gap 17 reliably avoids contact and electrical short circuits completely.

Alternatively, the induction loop 13I of the soldering tool can have an enclosure with which the contact element 14 can be pressed onto the plate and positioned (not shown here). The enclosure is made, for example, of a thermally stable plastic or a ceramic and is in particular not soft magnetic.

Alternatively, the contact element 14 can also have an electrically insulating intermediate layer or enclosure on its surface facing the soldering tool 13, made, for example, of a thermally resistant plastic or a ceramic.

The compact soldering tool 13 according to the invention can be implemented to be movable without problems and, for example, can, using robots, be placed with reproducible positions on a pane to be processed. This will be preferred, for example, if no large numbers of always consistent panes are to be processed, or if frequent model changes are to be processed on the same device.

Of course, the soldering tool 13 can also be arranged in a fixed position/stationary in the device 100. The respective pane 1 to be processed is then placed by means of conveyors (not shown) on the support means 11 and moved to the soldering tool 13 with interposition of the contact element 14.

To establish the solder connections, the induction loop 13I is supplied with current of the desired frequency (for example, 900 kHz) by switching on its power supply (closing the switch 13S). A typical power in the range from 0.2 kW to 15 kW is set, which can be varied depending on the distance from the loop, (total) area of the solder joints, and the masses to be heated. The magnetic field penetrates the air gap 17 or any possible intermediate layers without excessive damping. The less air gaps or intermediate layer material, the less damping.

Heat that heats the adjacent solder deposit 9 is generated in the metallic and, in particular, ferromagnetic components of the contact element 14.

A high frequency according to the invention of the induction voltage of, for example, 900 kHz results in a magnetic field with only a small penetration depth. This has the particular advantage that although the contact element 14, the solder deposit 9 positioned on the second solder connection surface 7, and, thus, indirectly, also the first solder connection surface 6 of the conductor structure 3 are reliably heated, the conductor structure 3 in the vicinity of the first solder connection surface 6 is heated only slightly. Thus, damage to the conductor structure 3 and detachment of the conductor structure 3 from the pane 1 are reliably prevented.

The required ON-time of the magnetic field until the complete melting of the solder deposit 9 and the best frequency range can be determined simply and quite reproducibly by tests and also simulated by suitable software. After the soldering operation, the magnetic field is switched off (opening the switch 13S). The pane 1 is still held in place for a short time, as are the counterholders, until the solder has solidified and the electrical connections are held in place even without additional mechanical fixation. After that, the pane 1 is fed for further processing.

To optimize the soldering operation and to avoid stresses in the pane 1 and the conductor structure 3, it can be advantageous to preheat the pane 1 together with the conductor structure 3 in the region of the first solder connection point 6 and its vicinity. For this, for example, a heater 20 can be arranged below the pane 1 (i.e., on the side facing away from the soldering tool 13 and the contact element 14).

FIG. 3A, 3B, and 3C depict in each case detailed representations of the exemplary induction loop 13I of FIG. 1. FIG. 3A depicts a plan view of a region of the induction loop 13I; and FIG. 3B, a side view from the left relative to the plan view of FIG. 3A.

In this example, the induction loop 13I is semicircular at an end region 13E. The semicircular end region 13E is connected to two parallel legs 13P. The two legs 13P and the end region 13E arranged between them form a U-shaped region 13U.

The radius of curvature R of the induction loop 13I in the end region 13E is, for example, 3 mm. The radius of curvature R is relative to the center of the hollow profiled element.

The length L of the induction loop 13I here is, for example, 20 mm; however, it can also be shorter or longer. Here, the length L includes the length of the legs 13P plus the length of the end region 13E. It goes without saying that the hollow profiled element can be longer in the further region and can then be connected via tube connections 13C and, optionally, other connections to the cooling unit (supply region 13Z). The induction loop 13I is made of a metal and thus also serves simultaneously as an electrical conductor which is supplied with the induction signal from the induction generator 13G.

The width B of the induction loop 13I (relative in each case to the center of the hollow profiled element) equals the distance between the legs 13P and is, for example, 6 mm.

The U-shaped region 13U is connected to the two tube connections 13C via the two parallel legs 13P, via which a coolant can be fed through the induction loop 13I. For this purpose, the induction loop 13I is made of a continuous hollow profiled element that is closed, apart from the tube connections 13C. For this, the hollow spaces of the legs 13P and of the end region 13E are connected to one another. A coolant can be passed through the interior of one leg 13P into the inner hollow space of the end region 13 and, through this, into the interior of the second leg 13P, thereby cooling the induction loop 13I.

FIG. 3C depicts a cross-sectional representation along the section plane, which is spanned by the section line X-X′ of FIG. 3A and the section line Y-Y′ of FIG. 3B. The induction loop 13I consists, in this example, of a hollow profiled element with a circular cross-section with an inner diameter Di of 1 mm and an outer diameter Da of 1.8 mm.

FIG. 4 depicts a cross-sectional representation of an alternative induction loop 13I consisting of a hollow profiled element with a rectangular cross-section. The inner diameter Di1 in the shorter dimension of the rectangular cross-section is, for example, 1 mm; the corresponding outer diameter Da1 is, for example, 1.8 mm. The inner diameter Di2 in the longer dimension of the rectangular cross-section is, for example, 2 mm; the corresponding outer diameter Da2 is, for example, 2.8 mm.

FIG. 5 depicts a perspective representation of another exemplary embodiment of an induction loop 13I according to the invention with an exemplary contact element 14 in the form of a bridge. The reversal region of the induction loop 13I is arranged above one of the two (second) solder connection surfaces 7 of the contact element 14.

FIG. 6A and 6B depict a detailed representation of another exemplary embodiment of an induction loop 13I according to the invention with a U-shaped region 13U rotated by 90° relative to the supply region 13Z. FIG. 6A depicts a plan view; and FIG. 6B, a side view from the left.

FIG. 7 depicts a detailed representation of another exemplary embodiment of an induction loop 13I according to the invention with a straight end region 13E.

The length L of the U-shaped region is, for example, 20 mm.

The width B of the induction loop 13I is, for example, 6 mm.

The end region 13E that connects the legs 13P is substantially rectilinear here. The radius of curvature at the transition between the end region 13E and the legs 13P is limited by the technical possibilities of the bending of the hollow profiled element and is, for example, 0.5 mm.

FIG. 8 depicts a detailed representation of another exemplary embodiment of an induction loop 13I according to the invention with a double-U-shape. Here, the induction loop 13I has two U-shaped regions 13U. The U-shaped regions 13U have, for example, in each case, a semicircular end region 13E with a radius of curvature R of, for example, 4 mm. The width B of the U-shaped regions 13U is, for example, 8 mm. Here, the two U-shaped regions 13U are, for example, connected to one another by a semicircular connection region 13V. Here, the distance A between the center lines of the U-shaped regions 13U is, for example, 16 mm.

FIG. 9 depicts a perspective representation of another exemplary embodiment of an induction loop 13I according to the invention with a rotated double-U-shape and an exemplary contact element 14 in the form of a bridge. This induction loop 13I is a further development of the induction loop 13I of FIG. 8. Here again, the induction loop 13I is made from two particularly advantageous U-shaped regions 13U, which, unlike the arrangement in one plane of FIG. 8, are rotated and thus aligned parallel to one another. As a result of this design, two (second) solder connection surfaces 7 of a bridge-shaped contact element 14 with an intermediate structure (in this case, a standard plug connection element) can be heated and soldered simultaneously. Here, the width B is, for example, 6 mm, the length L=20 mm, and the distance A=16 mm.

It goes without saying that in all exemplary embodiments presented here, the induction loop 13I can also be made of a solid metal profile, in particular if the induction voltage is applied for only a short time or pulsed and, consequently, cooling can be dispensed with.

It further goes without saying that all induction loops 13I depicted here by way of example can have metal profiled elements and in particular hollow profiled elements with any cross-section, for example, circular, oval, rectangular, square, or triangular cross-sections.

It further goes without saying that all induction loops 13I according to the invention depicted here can be adapted in their dimensions, such as length L, width B, and radius of curvature R, and in their shapes to the conditions of the individual case. The U-shape or the double-U-shape with the dimensions according to the invention is particularly universal and can be used for a large variety of connection elements.

### REFERENCE CHARACTERS

1 plate/pane

2 solder joint

3 conductor structure

4 busbar

5 heating conductor,

5′ antenna conductor

6 first solder connection surface

7 second solder connection surface

9 solder deposit

11 support means

13 soldering tool

13C tube connections

13E end region, reversal region

13G induction generator

13I induction loop

13P leg

13S switch

13U U-shaped region

13V connection region

13Z supply region

14 contact element

17 air gap

18 counterholder

19 electrical supply line

20 heater

100 device

A distance

B width

L length

Di, Di1, Di2 inner diameter

Da, Da1, Da2 outer diameter

R, R1 radius

X-X′, Y-Y′ section line

Z region

1. Soldering tool for inductive soldering, comprising
an induction loop and
an induction generator that is electrically conductively connected to the induction loop,
wherein the induction loop
consists of a metal profiled element,
has at least one U-shaped region or two U-shaped regions, and each U-shaped region has in each case two legs and an end region connecting the legs,
the at least one U-shaped region has a length L of at least 3 mm.

2. The soldering tool according to claim 1, wherein the end region is rounded.

3. The soldering tool according to claim 1, wherein the end region has a first arcuate section, a rectilinear section, and a second arcuate section.

4. The soldering tool according to claim 1, wherein the induction loop has no soft magnetic material in its active area.

5. The soldering tool according to claim 1, wherein the induction loop contains or is substantially made of copper or silver-plated copper, aluminum, or metallic sintered materials.

6. The soldering tool according to claim 1, wherein the induction loop has, at least in sections, a non-magnetic enclosure.

7. The soldering tool according to claim 1, wherein the induction loop is a hollow profiled element.

8. Device for inductive soldering of at least one contact element to at least one conductor structure on a nonmetallic plate, comprising
means for fastening a plate during the soldering operation,
at least one soldering tool (13) according to claim 1 having at least one induction loop suitable for radiating a magnetic field,
means for mutually positioning the soldering tool and a contact element such that the switched-on magnetic field of the soldering tool heats the contact element and thus the solder joint.

9. The device according to claim 8, wherein the induction loop is arranged such that, in the end region, the induction loop has a minimum distance from the contact element.

10. The device according to claim 8, wherein the soldering tool or the contact element is equipped with an electrically insulating intermediate layer for applying the induction loop on the contact element.

11. The device according to claim 8, wherein the device includes at least one counterholder for pressing the contact element onto the plate.

12. The device according to claim 11, wherein the counterholder and, optionally, the gripping tool have no components for directing and guiding the field lines of the magnetic field.

13. Method for inductively soldering at least one ferromagnetic contact element to at least one conductor structure on a nonmetallic plate, the method comprising:
providing a nonmetallic plate having at least one conductor structure arranged thereon and at least one first solder connection surface,
providing at least one contact element made of a ferromagnetic stainless steel and having at least one second solder connection surface,
arranging at least one solder deposit, at least in sections, on the first solder connection surface or the second solder connection surface or on both,
arranging the second solder connection surface on the first solder connection surface, wherein the solder deposit is arranged, at least in sections, between the first solder connection surface and the second solder connection surface,
radiating a magnetic field with a predefined frequency by a soldering tool according to claim 1 including an electrically supplied induction loop into the contact element, in order to heat it by induction and to melt the solder deposit positioned thereon.

14. The method according to claim 13, wherein the end region of the induction loop is applied to the contact element directly or via an electrically insulating intermediate layer or with a narrow air gap.

15. The method according to claim 13, wherein a first solder connection surface of the conductor structure on the plate or a second solder connection surface of the contact element or both are provided with a lead-containing or lead-free solder deposit.

16. The soldering tool according to claim 1, wherein the length L is from 3 mm to 500 mm, and the width B is from 4 mm to 25 mm.

17. The soldering tool according to claim 2, wherein the end region is semicircular with a radius R of 2 mm to 20 mm.

18. The soldering tool according to claim 3, wherein the first arcuate section and the second arcuate section have a curvature angle R1 of 0.5 mm to 5 mm.

19. The soldering tool according to claim 6, wherein the non-magnetic enclosure is a non-soft-magnetic enclosure made of a thermally resistant plastic or a ceramic.

20. The soldering tool according to claim 1, wherein the induction loop has at least two tube connections that are connected to a hollow space arranged in the interior of the induction loop.
